(19) United States
(12) Patent Application Publication
(10) Pub. No.: US 2025/0292412 A1
(43) Pub. Date: Sep. 18, 2025

(54) EYELASH REMOVAL FOR HIGH-RESOLUTION ULTRA-WIDE-FIELD FUNDUS IMAGES

(71) Applicant: The Hong Kong Polytechnic University, Hung Hom (HK)

(72) Inventors: Mingguang HE, Hung Hom (HK); Danli SHI, Hung Hom (HK); Weiyi ZHANG, Hung Hom (HK)

(73) Assignee: The Hong Kong Polytechnic University, Hung Hom (HK)

(21) Appl. No.: 18/608,548

(22) Filed: Mar. 18, 2024

(51) Int. Cl. G06T 7/174; G06T 3/4053; G06T 5/10; G06T 5/77

(52) U.S. Cl. CPC G06T 7/174; G06T 3/4053; G06T 5/10; G06T 5/77; G06T 2207/20081

(57) ABSTRACT

A method allows virtual eyelash removal in high-resolution ultra-wide-field fundus images. A deep learning approach removes eyelash artifacts from UWF fundus images, enhancing clinical utility by providing clearer and accurate images for analysis and diagnosis. A high-resolution segmentation and image inpainting model obtains a super ultra-wide-field fundus image that virtually removes eyelashes and retains high resolution and high realism from a UWF fundus image with occluding eyelashes.

### BACKGROUND OF THE INVENTION

### 1. Field of the Invention

The present invention relates specifically to a method for eyelash removal in high-resolution ultra-wide-field fundus images. Fundus photography is an important way of examining the fundus, defined as the inside, and back surface of the eye. The fundus is made up of the retina, macula, optic disc, fovea and associated blood vessels. Fundus photography has the advantages of being easy to acquire, non-invasiveness, and quick performance; in clinical practice, doctors can analyze these images for evidence of abnormalities such as myopia, macular atrophy, or even diabetes, hypertension and/or heart disease. This type of imaging can also enhance the creation of specific treatment plans through detailed screening and diagnosis.

In recent years, Ultra-Wide-Field (UWF) fundus imaging has been increasingly used as a promising technique that can capture a larger retinal field of view than conventional fundus photography. However, in real-life scenarios, UWF images are often obscured by eyelids and eyelashes, and these artifacts may affect the screening performance of machine learning models trained on clean images. Several studies have also shown that the presence of artifacts such as eyelids and eyelashes has become a significant barrier to making reliable retinal disease diagnoses. Therefore, methods that use deep learning to remove eyelash regions from ultra-wide-field fundus images and retain the high resolution and rich detail of the original image would be useful.

### 2. Description of the Related Art

Existing studies in ultra-wide-field fundus images have focused on avoiding the eyelash region by applying rotating and cropping techniques, but these methods lose detail outside the eyelash region and have limitations in retaining under-eye image information. Known methods performing eyelash removal for iris recognition tasks, often segmenting the eyelash region based on image intensity using traditional image processing such as edge detection and thresholding, are unable to achieve satisfactory results in medical/diagnostic applications. This is due to their reliance on grey-scale maps and the fact that the image data is much simpler than that of UWF fundus images.

### SUMMARY OF THE INVENTION

The present invention allows for the virtual removal of eyelashes in high-resolution UWF fundus images. The present invention uses a high-resolution, segmentation model developed specifically for the virtual removal of eyelashes in UWF fundus images. The invention can be applied to improve the efficiency and quality of image acquisition, such as data repair when diagnosing fundus diseases, or data cleaning and augmentation when using UWF fundus images for research. The invention designs a two-stage architecture including segmentation and inpainting models.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and/or other aspects and advantages of the invention will become apparent and more readily appreciated from the following description of the embodiments, taken in conjunction with the accompanying drawings of which:

FIG. 1 is a flowchart detailing the steps of the method of the invention.

FIG. 2 is an abstract flow diagram showing details of one of the steps of the method of the invention.

FIG. 3 is a set of original images, masked images, and output images produced by the method of the invention.

FIG. 4 is a set of representative images, segmentation masks, and expanded segmentation masks as produced by the method of the invention.

FIG. 5 is an abstracted block diagram of an apparatus for carrying out the method of the invention.

FIG. 6 is an abstracted block diagram of an ultra-wide fundus photography device.

### DETAILED DESCRIPTION OF THE EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

For purposes of this application, the following acronyms will be used:
A) UWFFP: Ultra-Wide-Field Fundus Photography, a technique which produces the imagery to be processed with the method of the invention.
B) UWFFPI: UWFFP Images, the images/image files/imaged data produced by a UWFFPD, stored in digital form for processing, and/or generated by the method of the invention.
C) UWFFPD: UWFFP Device, a device (or collection of devices which work in the appropriate sequence) to collect UWFFPI and process them using the method of the invention.

Though useful for many applications, the invention will be described in terms of a method of correcting UWFFPI by virtually removing eyelashes. the UWFFPI is produced and processed by a UWFFPD under the control and/or administration of a doctor, nurse, technician or other health worker and/or imaging analyst (hereafter, referred to as one or more “users”), It will be apparent to persons of ordinary skill in the art that a UWFFPD can also be used for detecting other health conditions or for any other suitable application that indicates the use of UWFFPI.

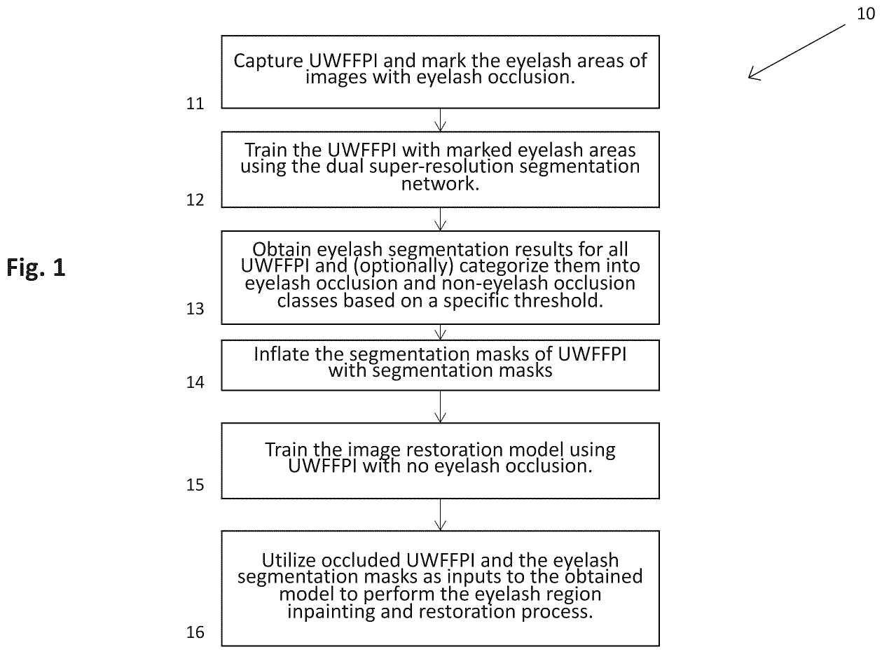

By referring to the provided drawings, the method of the invention can be easily understood. FIG. 1 shows flowchart 10 with the steps of the method of the invention.

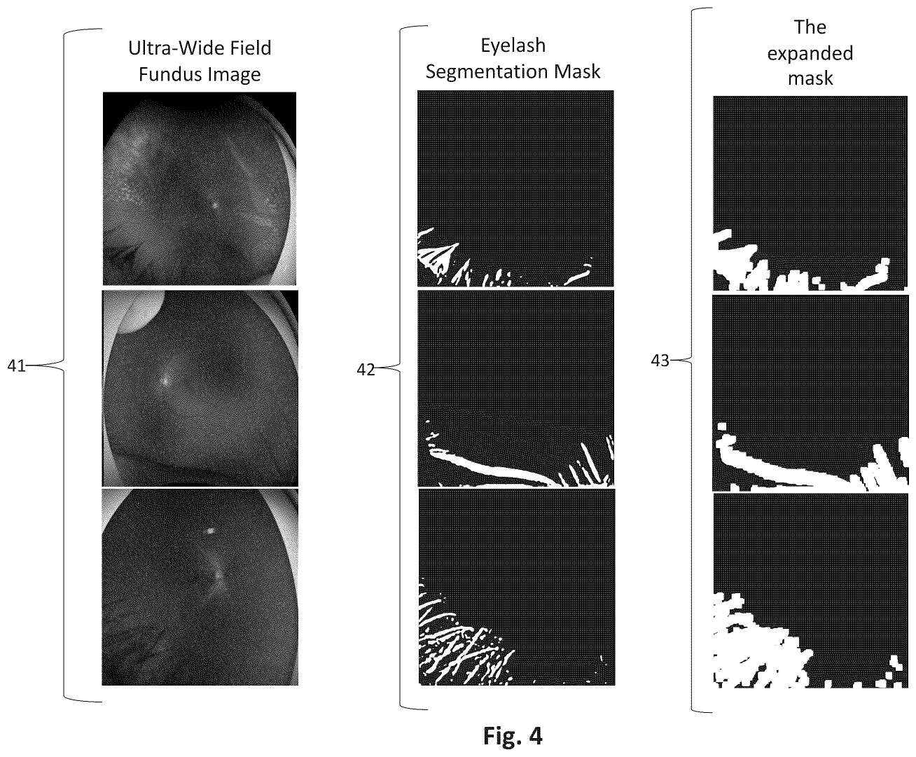

In Step 11, the UWFFPD is used to acquire one or more UWFFPI (see FIG. 4, first column 41), one or more of the UWFFPI including eyelashes, and one or more of the UWFFPI containing eyelashes manually selected by a user for annotation of the eyelash region. The eyelashes in the selected UWFFPI are marked or otherwise isolated by the user, and those markings are used to generate segmentation masks. (See FIG. 4, second column 42.)

In Step 12, the annotated UWFFPI and segmentation masks obtained in Step 11 are input into a Dual Super-Resolution Learning (DSRL) network for training to obtain a model capable of segmenting the eyelash region in high-resolution images. The DSRL model uses a dual-stream framework comprising a semantic segmentation super-resolution module, a single-image super-resolution module and a feature attention module. Preferably, the semantic segmentation super-resolution module adds an additional up-sampling operation to the segmentation to generate the final mask (see FIG. 4, third column 43) while maintaining the number of small parameters; the single-image super-resolution module shares the feature extractor with the semantic segmentation super-resolution module and draws on sub-pixel convolution to reduce computational effort and produce high-quality results, which can effectively reconstruct the fine-grained structural information and build high-resolution images; in addition, the feature attention module is introduced to guide the semantic segmentation super-resolution module in learning high-resolution representations, helping to enhance high-resolution representations with detailed structural information.

In Step 13, all of the UWFFPI acquired in Step 11 are fed into the segmentation model obtained in Step 12 to obtain a mask for eyelash segmentation. Optionally, the method can include calculating a value “r” for the proportion of the segmented region to the full image; images with “r” greater than some fixed minimum area of the image are labelled as images with eyelash occlusion and are partitioned into an occluded set of UWFFPI, while the rest are labelled as images without eyelash occlusion and are partitioned into a non-occluded set of UWFFPI. A fixed minimum area corresponding to 3% of the area of the original image is known to produce reasonable results while minimizing the number of images which are unnecessarily processed.

In Step 14, a convolutional kernel size of appropriate size for the resolution of the UWFFPI in the occluded set of UWFFPI (for the images as described in this application, 35×20pixels) is used to inflate the segmented region in the segmentation mask of the images in the occluded set of UWFFPI.

In Step 15, the non-occluded set of UWFFPI is fed into an image restoration model such as the Large Mask Inpainting with Fourier Convolutions or “LaMa” for fine-tuning training of the random dynamic mask restoration. Preferably, a network structure based on Fast Fourier Convolution (FFC) is used in the LAMA model to construct a network that allows the model to have a larger field of perception at the initial stage of the network, where the input of the FFC is divided into two branches, the local branch using conventional convolution and the global branch using Fast Fourier Transform, and the two branches are merged at the output. Furthermore, the model assesses feature similarity by comparing the original UWFFPI with the output UWFFPI, which involves a field perceptual loss and a counteracting loss, to achieve extensive perceptual fields while preserving the consistency of features in the UWFFPI before and after eyelash removal.

In Step 16, the inflated segmentation masks obtained in Step 4 are input into the model with the corresponding original UWFFPI captured in Step 11 after fine-tuning in Step 15, and the de-surfing and restoration work of the eyelash region is performed to output the restored eyelash-free HD ultra-wide-field fundus images.

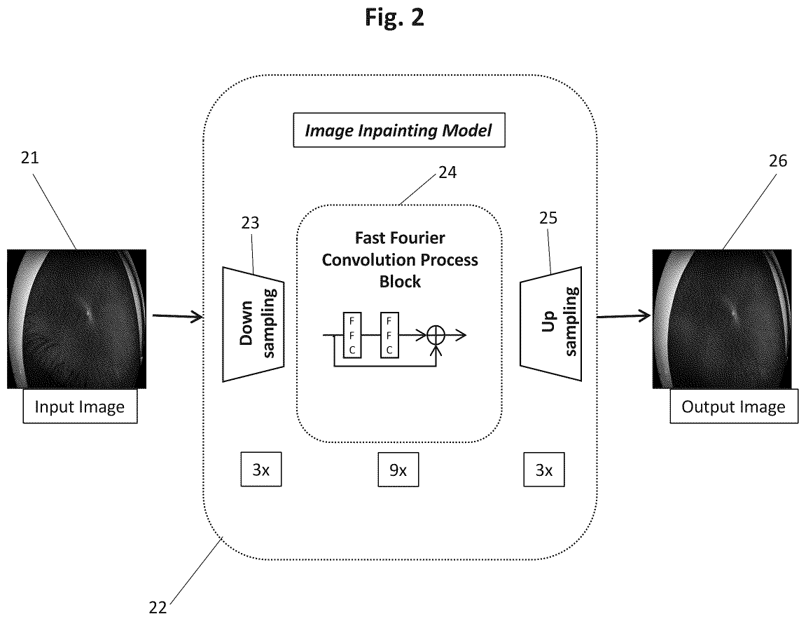

FIG. 2 shows a specific flow of the image processing of Step 15 and Step 16 (see FIG. 1). The original UWFFPI is input into image inpainting model 22, where it is downsampled by downsampling process 23. It is then input into a Fast Fourier Convolution Process 24 and processed by the Fast Fourier Convolution Process 24 with the inflated segmentation masks obtained in Step 4 (see FIG. 1), producing a downsampled output image, wherein the areas formerly occluded by eyelashes are inpainted with the method's generated replacement image segments. The downsampled output image is then upsampled by upsampling process 25, producing output image 26.

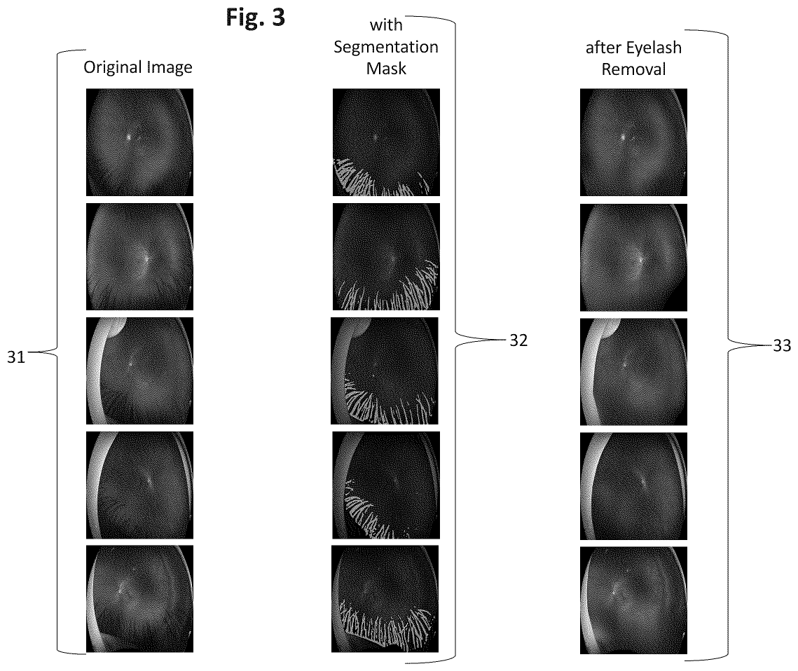

FIG. 3 shows the input, mid-process, and output images produced by the method of the invention. Original image column 31 shows a variety of original UWFFPI generated by a UWFFPD. Each image has been processed up to the point of Step 14 (see FIG. 1) and includes an inflated segmentation mask, resulting in the masked UWFFPI of masked image column 32. After the method of the invention as described in association with FIGS. 1 and 2 above is performed, the output images shown in output image column 32 are generated for examination by a user.

FIG. 4 shows details of the segmentation mask inflation. The original UWFFPI of the first column 41 include various eyelash occlusions. The segmentation masks of the second column 42 correspond to the original UWFFPI immediately to their left in the first column 41, and were produced during Step 11 (see FIG. 1). The inflated masks produced during Step 14 are likewise shown in the third column 43, with each inflated mask corresponding to the segmentation mask immediately to its left.

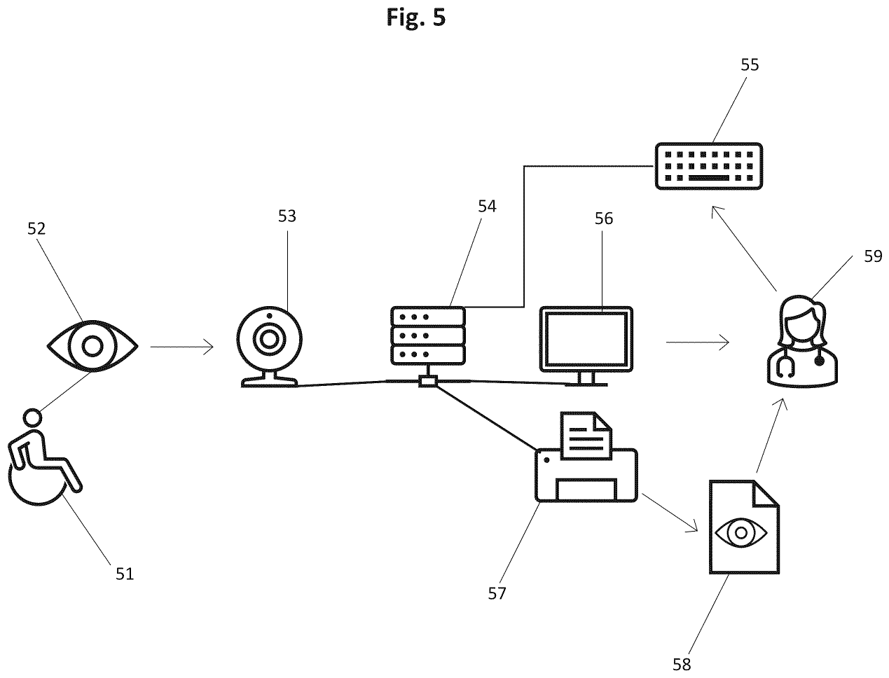

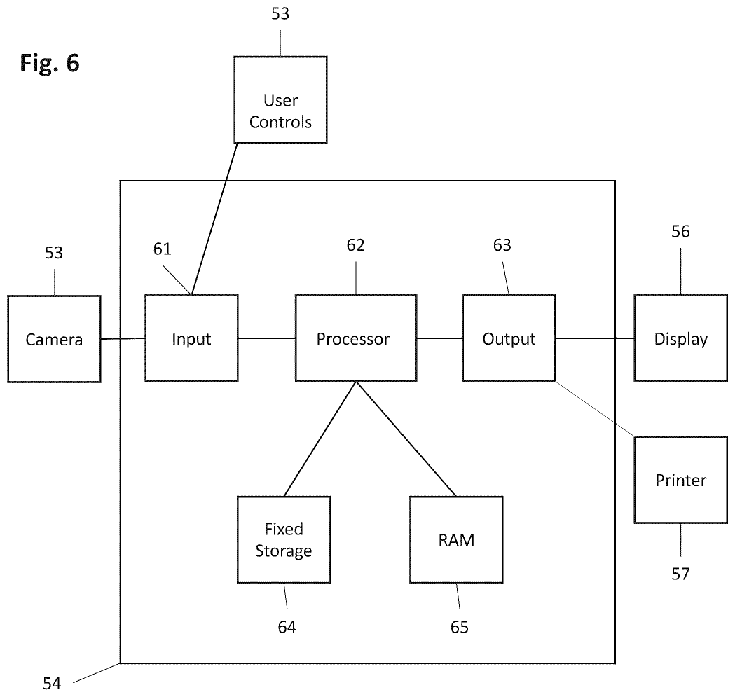

FIG. 5 shows an apparatus for applying the method of the invention. Patient 51 allows UWFFPD 54 (see also FIG. 6) to obtain UWFFPI of eye 52 through camera 53. Camera 53 may be integrated into UWFFPD 54 or connected by wire or wirelessly. User 59 uses user controls 55 (here a keyboard) to control the operation of UWFFPD 54 in obtaining the UWFFPI, processing them, and displaying them. UWFFPD 54 processes the UWFFPI as described above in Steps 11 through 16, and then displays the generated UWFFPI with the occluding eyelashes removed on display 56, prints them on printer 57 to produce printed UWFFPI 56, or both, to allow user 59 to review the UWFFPI for diagnostic and treatment planning purposes.

FIG. 6 shows a block diagram of the UWFFPD. User controls 53 and camera 53 are connected to an input system 61, which could comprise a Bluetooth® connection, a USB connection, a proprietary hardwired or wireless system, or any other means of connecting them as desired. Input system 61 (which can also constitute two separate systems, one for each input device) sends the user control inputs and the camera data to processor 62. Fixed storage 64 (which could be a hard drive, a solid state drive, flash RAM, or any other desired means of persistently storing information) and/or random access memory (RAM) 65 contain(s) a software program or “instruction” having multiple executable code elements embodying the method of the invention which are executed by processor 62. Note that processor 62 could compromise a CPU, a GPU, a proprietary processor, or any reasonable combination thereof. Input data and processing data generated while applying the various steps of the method of the invention are also stored in RAM 65 and/or fixed storage 64. Once the input data has been processed by processor 62 and the final generated occluding-eyelash-free UWFFPI stored in fixed storage 64 and/or RAM 65 (or offloaded to cloud storage, portable storage, or otherwise stored in final form for review) the generated UWFFPI can be displayed on display 56, printed on printer 57, or offloaded as previously stated for review by a user (see FIG. 5).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of virtual eyelash removal for ultra-wide-field fundus images comprising the steps of:
obtaining a set of original ultra-wide-field fundus images;
determining if any of the set of original ultra-wide-field fundus images has one or more occluding eyebrows, and if so, marking the one or more occluding eyebrows to identify the one or more occluding eyebrows for later processing and adding a corresponding member of the set of original ultra-wide-field fundus images to a set of occluded images;
creating a set of segmentation masks, each member of the set of segmentation masks corresponding to the occluding eyebrows in one member of the set of occluded images;
inputting the set of occluded images and the set of segmentation masks into a dual super-resolution learning network (DSRLN) for training to obtain a DSRLN model capable of segmenting the one or more occluding eyebrows in the set of occluded images to generate a set of refined segmentation masks, each member of the set of refined segmentation masks corresponding to a member of the set of occluded images;
generating a set of inflated segmentation masks by processing each member of the set of refined segmentation masks to produce a corresponding member of the set of inflated segmentation masks;
inputting the set of occluded images into an image restoration model;
generating one or more final generated images by inputting the set of inflated segmentation masks and the corresponding members of the set of original ultra-wide-field fundus images into the image restoration model to generate a set of final generated images, each member of the set of final generated images comprising a member of the set of original ultra-wide-field fundus images with the corresponding one or more occluding eyebrows virtually removed by inpainting in a region of the corresponding member of the set of inflated segmentation masks; and
displaying the set of final generated images to a user.

2. The method of virtual eyelash removal for ultra-wide-field fundus images of claim 1, wherein the DSRL model uses a dual-stream framework comprising a semantic segmentation super-resolution module, a single-image super-resolution module and a feature attention module.

3. The method of virtual eyelash removal for ultra-wide-field fundus images of claim 2, wherein the semantic segmentation super-resolution module further comprises an additional up-sampling step to generate the members of the set of inflated segmentation masks.

4. The method of virtual eyelash removal for ultra-wide-field fundus images of claim 1, wherein the image restoration model uses a Fast Fourier Convolution process, the Fast Fourier Convolution process comprising a Fast Fourier Transform process generating a global branch output and a traditional convolution process generating a local branch output, the global branch output and the local branch output being merged to create a final output of the Fast Fourier Convolution process.

5. The method of virtual eyelash removal for ultra-wide-field fundus images of claim 2, wherein the image restoration model uses a Fast Fourier Convolution process, the Fast Fourier Convolution process comprising a Fast Fourier Transform process generating a global branch output and a traditional convolution process generating a local branch output, the global branch output and the local branch output being merged to create a final output of the Fast Fourier Convolution process.

6. The method of virtual eyelash removal for ultra-wide-field fundus images of claim 3, wherein the image restoration model uses a Fast Fourier Convolution process, the Fast Fourier Convolution process comprising a Fast Fourier Transform process generating a global branch output and a traditional convolution process generating a local branch output, the global branch output and the local branch output being merged to create a final output of the Fast Fourier Convolution process.

7. The method of virtual eyelash removal for ultra-wide-field fundus images of claim 1, further comprising the steps of:
selecting a convolutional kernel size of appropriate size for the resolution of the members of the set of original ultra-wide-format fundus images; and
using the convolutional kernel size as an inflation size guide when generating the set of inflated segmentation masks.

8. The method of virtual eyelash removal for ultra-wide-field fundus images of claim 2, further comprising the steps of:
selecting a convolutional kernel size of appropriate size for the resolution of the members of the set of original ultra-wide-format fundus images; and
using the convolutional kernel size as an inflation size guide when generating the set of inflated segmentation masks.

9. The method of virtual eyelash removal for ultra-wide-field fundus images of claim 3, further comprising the steps of:
selecting a convolutional kernel size of appropriate size for the resolution of the members of the set of original ultra-wide-format fundus images; and
using the convolutional kernel size as an inflation size guide when generating the set of inflated segmentation masks.

10. The method of virtual eyelash removal for ultra-wide-field fundus images of claim 4, further comprising the steps of:
selecting a convolutional kernel size of appropriate size for the resolution of the members of the set of original ultra-wide-format fundus images; and
using the convolutional kernel size as an inflation size guide when generating the set of inflated segmentation masks.

11. The method of virtual eyelash removal for ultra-wide-field fundus images of claim 5, further comprising the steps of:
selecting a convolutional kernel size of appropriate size for the resolution of the members of the set of original ultra-wide-format fundus images; and
using the convolutional kernel size as an inflation size guide when generating the set of inflated segmentation masks.

12. The method of virtual eyelash removal for ultra-wide-field fundus images of claim 6, further comprising the steps of:
selecting a convolutional kernel size of appropriate size for the resolution of the members of the set of original ultra-wide-format fundus images; and
using the convolutional kernel size as an inflation size guide when generating the set of inflated segmentation masks.

13. The method of virtual eyelash removal for ultra-wide-field fundus images of claim 1, wherein a member of the set of original ultra-wide-format fundus images is not added to the set of occluded images unless an occluded area comprising all areas of the member of the set of original ultra-wide-format fundus images occluded by the one or more occluding eyebrows exceeds a fixed minimum area of the member of the set of original ultra-wide-format fundus images.

14. The method of virtual eyelash removal for ultra-wide-field fundus images of claim 2, wherein a member of the set of original ultra-wide-format fundus images is not added to the set of occluded images unless an occluded area comprising all areas of the member of the set of original ultra-wide-format fundus images occluded by the one or more occluding eyebrows exceeds a fixed minimum area of the member of the set of original ultra-wide-format fundus images.

15. The method of virtual eyelash removal for ultra-wide-field fundus images of claim 3, wherein a member of the set of original ultra-wide-format fundus images is not added to the set of occluded images unless an occluded area comprising all areas of the member of the set of original ultra-wide-format fundus images occluded by the one or more occluding eyebrows exceeds a fixed minimum area of the member of the set of original ultra-wide-format fundus images.

16. The method of virtual eyelash removal for ultra-wide-field fundus images of claim 4, wherein a member of the set of original ultra-wide-format fundus images is not added to the set of occluded images unless an occluded area comprising all areas of the member of the set of original ultra-wide-format fundus images occluded by the one or more occluding eyebrows exceeds a fixed minimum area of the member of the set of original ultra-wide-format fundus images.

17. The method of virtual eyelash removal for ultra-wide-field fundus images of claim 8, wherein a member of the set of original ultra-wide-format fundus images is not added to the set of occluded images unless an occluded area comprising all areas of the member of the set of original ultra-wide-format fundus images occluded by the one or more occluding eyebrows exceeds a fixed minimum area of the member of the set of original ultra-wide-format fundus images.

18. An apparatus, comprising a processor coupled to a memory, a fixed storage system, an input system, and an output system, wherein the fixed storage is configured to store an instruction, and the processor is configured to execute the instruction stored in the memory for:
obtaining a set of original ultra-wide-field fundus images;
determining if any of the set of original ultra-wide-field fundus images has one or more occluding eyebrows and if so marking the one or more occluding eyebrows to identify the one or more occluding eyebrows for later processing and adding the corresponding member of the set of original ultra-wide-field fundus images to a set of occluded images;
creating a set of segmentation masks, each member of the set of segmentation masks corresponding to the occluding eyebrows in one member of the set of occluded images;
inputting the set of occluded images and the set of segmentation masks into a dual super-resolution learning network for training to obtain a DSRL model capable of segmenting the one or more occluding eyebrows in the set of occluded images to generate a set of refined segmentation masks, each member of the set of refined segmentation masks corresponding to a member of the set of occluded images;
generating a set of inflated segmentation masks by processing each member of the set of refined segmentation masks to produce a corresponding member of the set of inflated segmentation masks;
inputting the set of occluded images into an image restoration model;
generating one or more final generated images by inputting the set of inflated segmentation masks and the corresponding members of the set of original ultra-wide-field fundus images into the image restoration model to generate a set of final generated images, each member of the set of final generated images comprising a member of the set of original ultra-wide-field fundus images with the corresponding one or more occluding eyebrows virtually removed by inpainting in a region of the corresponding member of the set of inflated segmentation masks; and
displaying the set of final generated images to a user.

19. The apparatus according to claim 18, wherein the processor is further configured to execute the instruction stored in the memory for:
using a Fast Fourier Convolution process in the image restoration model, the Fast Fourier Convolution process comprising a Fast Fourier Transform process generating a global branch output and a traditional convolution process generating a local branch output, the global branch output and the local branch output being merged to create a final output of the Fast Fourier Convolution process.

20. The apparatus according to claim 18, wherein the processor is further configured to execute the instruction stored in the memory for:
selecting a convolutional kernel size of appropriate size for the resolution of the members of the set of original ultra-wide-format fundus images; and
using the convolutional kernel size as an inflation size guide when generating the set of inflated segmentation masks.
